(19) United States
(12) Patent Application Publication
(10) Pub. No.: US 2013/0137169 A1
(43) Pub. Date: May 30, 2013

(54) MICROCHIP AND METHOD OF PRODUCING THE SAME

(71) Applicant: Sony Corporation, Tokyo (JP)

(72) Inventor: Kensuke Kojima, Kanagawa (JP)

(73) Assignee: Sony Corporation, Tokyo (JP)

(21) Appl. No.: 13/682,390

(22) Filed: Nov. 20, 2012

(30) Foreign Application Priority Data
Nov. 28, 2011 (JP) 2011-259324

(51) Int. Cl. G01N 21/64

(52) U.S. Cl. CPC G01N 21/6486
USPC 435/289.1; 156/60; 156/221

(57) ABSTRACT

Provided is a microchip including a plurality of substrates, a reaction zone configured to function as a reaction site of a reaction, and a circumferential path on a circumferential part of the reaction zone with an inside of the circumferential path being at a pressure negative to atmospheric pressure, in which the circumferential path is disposed on at least one side of at least one of the substrates bonded together.

### CROSS REFERENCES TO RELATED APPLICATIONS

The present application claims priority to Japanese Priority Patent Application JP 2011-259324 filed in the Japan Patent Office on Nov. 28, 2011, the entire content of which is hereby incorporated by reference.

### BACKGROUND

The present disclosure relates to a microchip and a method of producing a microchip, more particularly to a microchip for performing chemical and biological analyses or the like in a reaction zone configured to function as a reaction site formed on a substrate, or the like.

In recent years, by applying a microfabrication technique in the semiconductor industry, microchips having wells and flow channels for performing chemical and biological analyses formed on a substrate made of silicon or glass have been developed.

Such analysis system using the microchips is referred to as μ-TAS (Micro-Total-Analysis-System), Lab-on-chip, biochip or the like, and attracts attention as a technology that can speed up, increase efficiency of, and integrate the chemical and biological analyses, or decrease a size of analysis apparatus.

Since the μ-TAS can analyze a small amount of samples and the microchips can be disposable (single-use), it is expected to apply it to the biological analysis that handles, specifically, a trace amount of precious samples or many test bodies.

An example of the application of the μ-TAS is an optical detector which introduces substances into a plurality of areas provided on microchips, and optically detects the substances. An example of the optical detector is an electrophoresis apparatus that separates a plurality of substances in flow channels on microchips by electrophoresis, and optically detects nuclear substances separated, a reaction apparatus (for example, a real time PCR apparatus) that proceeds reactions of a plurality of substances in wells on microchips, and optically detects substances produced, or the like.

Japanese Unexamined Patent Application Publication No. 2006-292408 discloses a biological sample discriminating plate that decreases diffused reflection that might be noise upon detection and can analyze accurately. Specifically, the biological sample discriminating plate includes flow channels, fluid reservoirs, and vacant holes through a substrate. A cover made of a material that transmits excitation light is bonded to cover all areas other than the vacant holes. Between the sample discriminating plate and the cover, the flow channels and the fluid reservoirs are formed. The flow channels are irradiated with the excitation light, and a fluorescent label contained in the liquid sample filled generates fluorescence. The vacant holes realize that almost no stray light is produced in the biological sample discriminating plate, and fluorescence is not generated from the adjacent fluid channels.

Japanese Unexamined Patent Application Publication No. 2005-249540 proposes a method of producing a microchip at least including a polydimethylsiloxane (PDMS) substrate, and a counter substrate bonded to the PDMS substrate. The method of producing the microchip is configured to have the following first to third steps. In the first step, a negative pressure pipeline is formed in a continuous ring shape around a circumferential border of both bonded sides of the PDMS substrates. In the second step, the air in the negative pressure pipeline of the PDMS substrate is exhausted and sucked to intimately contact the PDMS substrate with the counter substrate. In the third step, the air in the negative pressure pipeline of the PDMS substrate is exhausted and sucked to vacuum bond the PDMS substrate to the counter substrate.

### SUMMARY

A variety of microchips and methods of producing the same with good optical detection accuracy are desired.

Thus, it is desired to provide a microchip and a method of producing the same with good optical detection accuracy.

According to an embodiment of the present disclosure, there is provided a microchip including a plurality of substrates, a reaction zone configured to function as a reaction site of a reaction, and a circumferential path on a circumferential part of the reaction zone with an inside of the circumferential path being at a pressure negative to atmospheric pressure, in which the circumferential path is disposed on at least one side of at least one of the substrates bonded together.

In the microchip in the past, light entered on the reaction zone is diffused, and light leaked to an adjacent reaction zone not addressed or light scattered produces unnecessary light that decreases an optical detection accuracy. However, according to the present disclosure, by disposing the circumferential path, the unnecessary light that decreases an optical detection accuracy can be guided (for example, refracted or reflected) in a desirable direction. Thus, it is possible to block invasion of the unnecessary light into an optical detection system, so that the optical detection accuracy can be improved.

A section form of the circumferential path may be desirably curved to block the unnecessary light for the optical detection. By curving, the unnecessary light for the optical detection is easily refracted or reflected to guide light in a desirable direction with ease. It may be possible to block invasion of the unnecessary light into a well and an optical detection system.

The circumferential path may desirably have thermal insulating properties. Thus, the circumferential part at a side wall of each reaction zone is surrounded, so that heat release from each reaction zone and invasion of heat into each reaction zone can be prevented. Therefore, the reaction temperature within the reaction zone may be easily controlled.

Each circumferential path may be connected to a communicating flow channel, and desirably a fluid (liquid, gas) will flow through the communicating flow channel into each circumferential path. By selecting the fluid to be flowed as appropriate, properties such as light blocking properties and thermal insulating properties may be improved.

It may be desirable that the circumferential paths be disposed on both surfaces of the substrate on which the reaction zone is formed. By disposing the circumferential paths on both surfaces, it is possible to further block the unnecessary light for the optical detection. When the inside of the circumferential path has the pressure negative to atmospheric pressure, the substrate including the reaction zone can be strongly adsorbed to each counter substrate. Also, when the circumferential path has the negative pressure, a permanent bonding etc. may be avoided so that the substrates are easily peeled after the microchip is used.

Desirably, the circumferential path may include a cutout. By disposing the cutout, the flow channels that connect each reaction zone disposed within the circumferential path are easily formed. By utilizing the flow channels, it will be possible that a reaction reagent and a sample liquid are easily introduced into each reaction zone in a short time.

A method of producing a microchip includes bonding substrate layers on which a circumferential path is formed at a circumferential part of a reaction zone configured to function as a reaction site on a surface of the substrate that is one of the substrate layers, at a pressure negative to atmospheric pressure, and sealing hermetically the circumferential path.

By disposing the circumferential path, the substrates can be easily bonded, and can be separated and cleaned for recycling after the microchip is used.

A section form of the circumferential path may desirably be curved to block the unnecessary light for the optical detection.

According to an embodiment of the present disclosure, there is provided a microchip and a method of producing the same with good optical detection accuracy.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic top view of a microchip A according to an embodiment of the present disclosure;

FIG. 2A is a schematic sectional view (FIG. 1: P1-P2 section) of a microchip A according to an embodiment of the present disclosure having a circumferential path 2 disposed on one side of the substrate a1 bonded, in which an excitation light can enter any sides thereof;

FIG. 2B is a schematic sectional view (FIG. 1: P1-P2 section) of a microchip A according to an embodiment of the present disclosure having circumferential paths 2 disposed on both sides of the substrate a1 bonded, in which an excitation light can enter any sides thereof;

FIG. 3A is a schematic view for illustrating a blocking of the unnecessary light of incident light L on the microchip A according to a first embodiment in which a first circumferential path 2a is disposed in an enter direction, with counter substrates a2 and a3 faced to the substrate a1 including a reaction zone omitted, and with light entered into the well 1 from bottom as a matter of convenience, but light may also enter from above;

FIG. 3B is a schematic view for illustrating a blocking of the unnecessary light of incident light L on the microchip A according to a second embodiment in which a second circumferential path 2b is disposed in an exit light direction, with counter substrates a2 and a3 faced to the substrate a1 including a reaction zone omitted, and with light entered into the well 1 from bottom as a matter of convenience, but light may also enter from above;

FIG. 3C is a schematic view for illustrating a blocking of the unnecessary light of incident light L on the microchip A according to a third embodiment in which the first circumferential path 2a and the second circumferential path 2b are disposed in enter and exit directions, with counter substrates a2 and a3 faced to the substrate a1 including a reaction zone omitted, and with light entered into the well 1 from bottom as a matter of convenience, but light may also enter from above;

FIGS. 4A to 4F are schematic top views each illustrating an example of the circumferential path 2 according to an embodiment of the present disclosure;

FIG. 5 is a schematic top view of a microchip A2 according to an embodiment of the present disclosure;

FIG. 6 is a schematic top view of a microchip A3 according to an embodiment of the present disclosure;

FIG. 7 shows a configuration of an optical detector for a calculation model using the microchip A according to an embodiment of the present disclosure and a microchip in the past;

FIG. 8 shows a configuration of a microchip and an optical detector for a calculation model using the microchip A according to an embodiment of the present disclosure and a microchip in the past;

FIG. 9 shows light flows of 100, 1000 and 10000 light beams by the calculation model;

FIG. 10 shows light flows of the microchips according to the embodiments of the present disclosure and of the microchips in the past when a distance from a light source to a bottom of the chip is adjusted to 0 to 20 mm in each chip by the calculation model; and

FIG. 11 is a graph showing a 3PD total arrival amount (when an amount of emitted light from light source is supposed to be 100%) around leak light by the calculation model.

### DETAILED DESCRIPTION

Hereinafter, embodiments of the present disclosure will be described with reference to drawings. The embodiments described below are provided for purposes of illustration only, and merely depict examples of typical embodiments of the present disclosure, and the scope of the present disclosure should not be construed narrower. The embodiments will be described in the following order.
1. A microchip
(1) A reaction zone
(2) A circumferential path
(3) A substrate
(4) Other embodiments of microchips
2. Method of producing a microchip
3. An optical detection method using a microchip

<1. A Microchip>

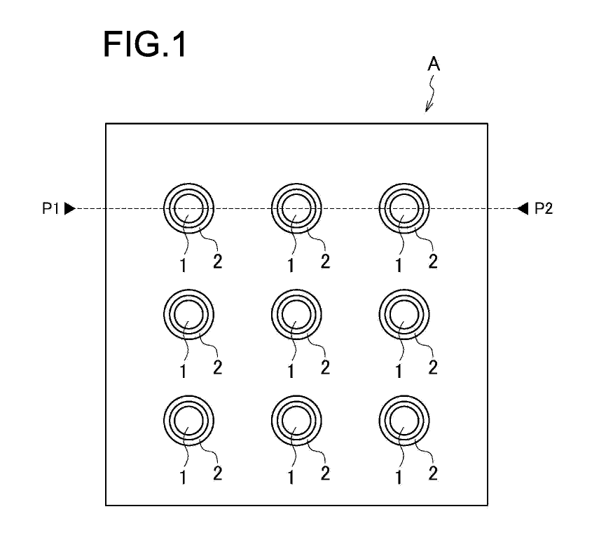

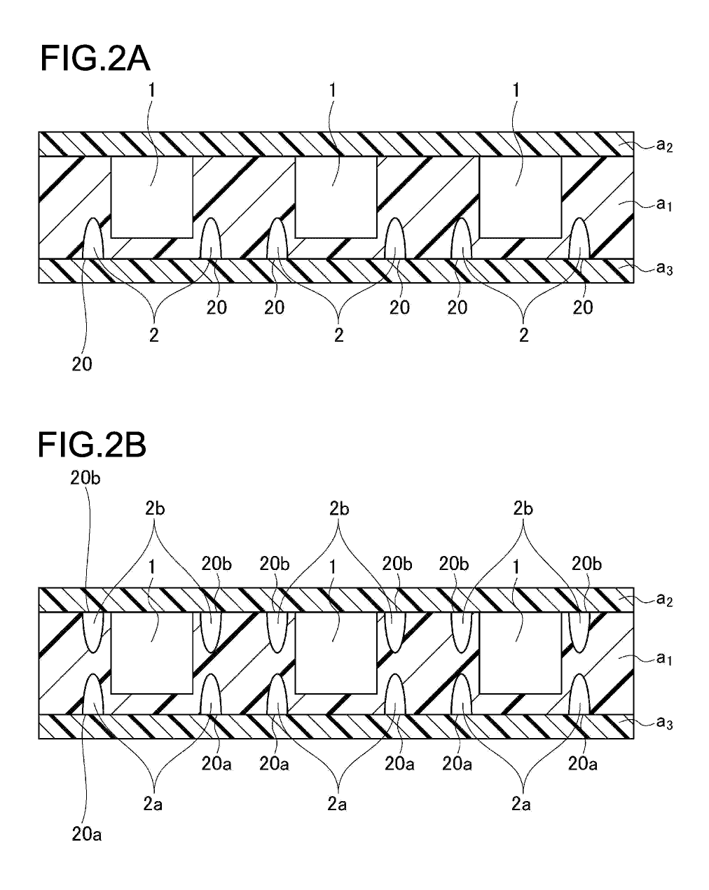

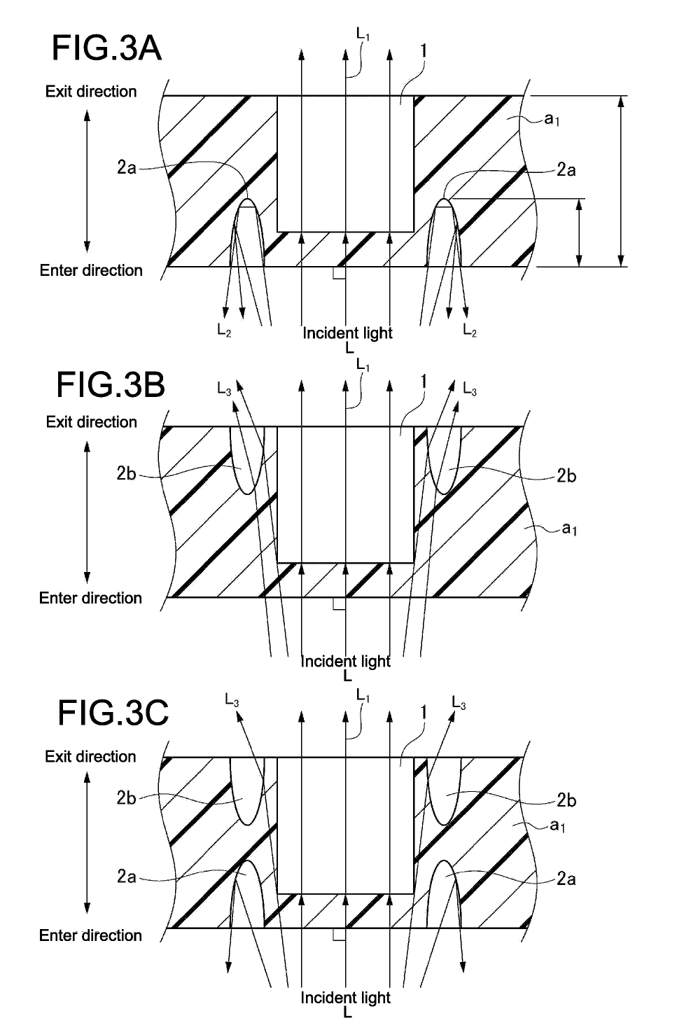

FIG. 1 shows a schematic top view of a microchip A according to an embodiment of the present disclosure, and FIGS. 2A, 2B and 3A to 3C show schematic sectional views thereof FIGS. 2A, 2B and 3A to 3C correspond to a P1-P2 section in FIG. 1, and show schematic sectional example illustrations of the microchip A.

FIGS. 3A to 3C are schematic views for each illustrating a blocking of the unnecessary light of incident light L on the microchip A according to an embodiment of the present disclosure.

Note that figures used for embodiments of the present disclosure may have simplified configurations etc. as a matter of convenience.

As shown in FIGS. 1, 2A and 2B, the microchip A according to an embodiment of the present disclosure includes a plurality of, e.g., at least two or three or more, substrates.

The microchip A includes a substrate a1 including a reaction zone 1 (hereinafter referred to as “well 1”) configured to function as a reaction site of a reaction and a circumferential path 2 on a circumferential part of each reaction zone 1, and at least one counter substrate bonded thereto.

The inside of the circumferential path 2 will be desirably at a pressure negative to atmospheric pressure. One or more of the counter substrates may be used. For example, substrates a2 and a3 may be used.

Using the microchip A according to an embodiment of the present disclosure, it is possible to improve optical detection accuracy in chemical and biological analyses in the reaction site as described later.

(1) Reaction Zone (Well)

As shown in FIGS. 1, 2A and 2B, a well 1 is an area of the reaction site in various reactions. One or more wells (zones) 1 are disposed in the substrate a1.

The form of the well 1 is not especially limited and includes ellipitic cylinder, cylinder, truncated cone, rectangular cylinder, polyhedral or the like, for example. The inside thereof may be tapered. It is desirable that the plane on/from which detection light enters or exits be flat. In the well 1, the reaction is performed for the chemical and biological analyses. Corresponding to the analyses to be intended, any substances to be detected and what is needed for the detection reaction may be disposed as appropriate. Examples include biological detection objects, synthetic oligo (oligonucleotide, nucleic acid-like synthetic substance and the like), synthetic oligo modified with a fluorescent pigment, enzymes, a buffer solution, salts, a solidifying agent such as wax, an antibody, a light source, a solvent such as water, or the like. Also, dNTPs, pigments or other substances used in a PCR method or a Loop-mediated Isothermal Amplification (LAMP) method may be disposed as appropriate.

(2) Circumferential Path

The circumferential path 2 having a pressure negative to atmospheric pressure at the circumferential part in each well 1 is desirably disposed on at least one side of the substrate a1 bonded to the counter substrate. The negative pressure at the inside of the circumferential path 2 can bond the substrate a1 with the counter substrate, i.e., a substrate a2 and/or a substrate a3.

According to the present disclosure, the circumferential path 2 is disposed around the circumferential part in each well 1, thereby blocking unnecessary light (leak light, scattered light, etc.) for the optical detection. Thus, the unnecessary light for the optical detection can be decreased to a degree that does not affect an S/N ratio.

Using the microchip according to an embodiment of the present disclosure, the optical detection accuracy can be improved. In addition, it is also advantageous in terms of costs and work efficiency, as the optical detection accuracy is improved by a simple way such as the microchip not by a measurement apparatus such as an optical detector or not by adjustment of measurement.

As described above, the inside of the circumferential path 2 desirably has a pressure negative to atmospheric pressure. As the inside of the circumferential path 2 has negative pressure and refractive index of light is increased, the unnecessary light will pass though outside the well. Even if the inside of the circumferential path 2 is at atmospheric pressure or negative pressure, light will be reflected at an interface, which is provided by a difference between refractive index of a PDMS resin and a refractive index of the inside of the circumferential path 2. When radial light flux exceeds the diameter of the well which will be the reaction zone, in order to prevent the unnecessary light at the circumferential part from passing through a chip or transmitting the inside of the chip, such that the unnecessary light does not leak to adjacent reaction zones (wells) and optical detection parts, the unnecessary light is scattered at the interface of the circumferential path. As a result, the unnecessary light is prevented from entering into the wells. Thus, it is possible to decrease invasion of the unnecessary light into the reaction zones and an optical detection system.

As the inside of the circumferential path 2 is the negative pressure, it is possible that the surface of the substrate a1 at the circumferential part of the well 1 and the surface(s) of the counter substrate a2 and/or a3 be sucked at reduced pressure. So, each well 1 can be sealed with the counter substrates a2 and a3. While the pressure of the inside of each well 1 is reduced and a sample liquid is injected into the well utilizing the reduced pressure, it is possible to maintain the bond between the substrates by the negative pressure within the circumferential path 2.

The inside of the circumferential path 2 can have negative pressure by bonding the substrate a1 including the circumferential path 2 and the counter substrate(s) a2 and/or a3 under reduced pressure. Such a bonding of the substrates can provide a microchip that a fluid (air, fluid) within the circumferential path 2 is exhausted and sucked at the same time. The microchip A has a structure that the substrate a1 and the counter substrates a2, a3 are vacuum bonded, in the atmosphere after bonding.

Not depending on the types of the substrates used, the substrates made of polydimethylsiloxane (PDMS) can fully maintain their bonding strength not by a permanent bonding but by only self-bonding by the negative pressure.

When a heating reaction proceeds within the well 1, the solution within the well is heated, whereby an internal pressure within the well 1 may be increased. In this case, as the inside of the circumferential path 2 has the negative pressure, the substrates are strongly bonded and well sealed in the microchip A according to an embodiment of the present disclosure so that a reaction liquid is less likely to leak from the well 1.

Also, according to the present disclosure, the circumferential path 2 can be involved in a temperature (heating and cooling) control in each well 1 of the microchip A, and particularly may have thermal insulating properties.

By the negative pressure of the inside of the circumferential path 2, a horizontal direction (or a perpendicular direction) around each well 1 (circumferential part) can be thermal-insulated when the microchip A is heated or cooled. So, the negative pressure of the inside of the circumferential path 2 is desirable. It will decrease heat release from the inside of the well 1 and decrease invasion of heat from circumference of each well 1.

Therefore, the reaction temperature within the reaction zone 1 is easily controlled, even when the reaction temperature within the reaction zone 1 is controlled by a heat controller (not shown) in the optical detector. This increases the reaction temperature control accuracy in each well 1 and decreases reaction condition variations in each well 1. In view of the above, the microchip according to an embodiment of the present disclosure can allow the reaction in each well 1 to proceed with high accuracy so that the detection accuracy of optical detection can be improved.

The circumferential path 2 is not a vacant hole penetrating through the substrate a1 in enter and exit directions, and is not penetrated, as shown in FIGS. 2A and 2B. Since the circumferential path 2 is not penetrated, the inside of the circumferential path 2 can be curved to reflect or refract light, as shown in FIGS. 2A and 2B. In addition, since the circumferential path 2 is not penetrated, the inside of the well 1 can be advantageously provided with thermal insulating properties and sucking properties to the counter substrates a2, a3 as well as the light blocking properties.

FIGS. 3A to 3C are schematic views for each illustrating a blocking of the unnecessary light of incident light L on the microchip A according to an embodiment of the present disclosure.

FIG. 3A is the microchip A according to a first embodiment of the present disclosure in which a first circumferential path 2a is disposed in an enter direction.

FIG. 3B is the microchip A according to a second embodiment of the present disclosure in which a second circumferential path 2b is disposed in an exit direction.

FIG. 3C is the microchip A according to a third embodiment of the present disclosure in which the first circumferential path 2a and the second circumferential path 2b are disposed in enter and exit directions.

Herein, based on the substrate a1, the light incident direction refers to “the enter direction” and the light exit direction refers to “the exit direction” (see FIGS. 3A to 3C). The enter direction and the exit direction refer to “the enter and exit directions” (for example, FIGS. 2A and 2B in a P1-P2 section in FIG. 1). The direction perpendicular to the enter and exit directions refers to “the perpendicular direction”.

The circumferential path 2 disposed in the enter direction refers to “the first circumferential path 2a ”, and the circumferential path 2 disposed in the exit direction refers to “the second circumferential path 2b ”.

The substrates a2, a3 facing to the substrate a1 having the reaction zone are omitted. In FIGS. 3A to 3C, light is shown to have entered into the well 1 from bottom as a matter of convenience. However, if the light enters from above, the same effects exerted by the circumferential path 2 can be provided.

The circumferential paths 2 formed in the substrate a1 of the microchip A according to an embodiment of the present disclosure are disposed on at least one side of the substrates a1 shown in FIG. 2A, FIGS. 3A and 3B. Among them, the first circumferential path 2a is desirable in that the unnecessary light of the incident light L can be eliminated efficiently.

The section form of the circumferential path 2 is desirably curved internally (for example, P1-P2 section in FIG. 1) in the enter and exit directions. By curving internally, much unnecessary light for the optical detection can be reflected and refracted (for example, see FIGS. 3A to 3B). Thus, the unnecessary light (leak light, scattered light, etc.) for the optical detection can be blocked to prevent contamination in the optical detection system.

The section form of the circumferential path 2 is desirably curved in a form to block the unnecessary light for the optical detection. Such a section form may desirably have a quadratic curve or a parabolic curve.

By curving the section form of the circumferential path 2, the light can be blocked more efficiently, as described above. Thus, it prevents invasion of the unnecessary light from adjacent wells into each optical detection system, and contamination can be decreased, thereby improving the optical detection accuracy in each well.

At the inside of the circumferential path 2, an opening 20 is disposed to suck and bond the substrate a1 and the counter substrates a2 and/or a3. The opening 20 is desirably faced to the enter direction or the exit direction. The opening 20 is desirably formed on the substrate so that a surface of the opening 20 is intimately contacted with a surface of the counter substrate.

When a thickness of the substrate having the well 1 (in the enter and exit directions) is 1, a height (depth) of the circumferential path 2, which is not penetrated, may be less than 1. From the standpoint of function effects such as light blocking properties, the height is desirably 0.5 to 0.1, more desirably about 0.4 to 0.2 (for example, see FIG. 3A). When the height (depth: H) of the circumferential path 2 is 1, a width (longest diameter: W) of the opening 20 is desirably 0.3 to 0.7, more desirably 0.4 to 0.6. The “height (depth)” is from “the opening 20” to “the top (bottom)” of the circumferential path 2.

A space (in a perpendicular direction) between the circumferential path 2 and an outer wall of the well 1 is not especially limited, but both are desirably close. When they are close, invasion of the unnecessary light into an optical detection system is easily decreased, and advantages such as thermal insulating properties and sucking properties are easily provided.

The circumferential path 2 is formed on at least either surface of the substrate a1 which is contacted with the counter substrate(s).

The form of the circumferential path 2 formed on the substrate a1 includes, for example, roughly elliptic annular form, (desirably roughly circle annular form), polygon such as triangle to icosagon annular form (desirably regular polygon annular form) and the like.

The section form of the circumferential path 2 in the enter and exit directions has desirably a steric form formed by rotating around a center axis of the well 1 (desirably at bottom).

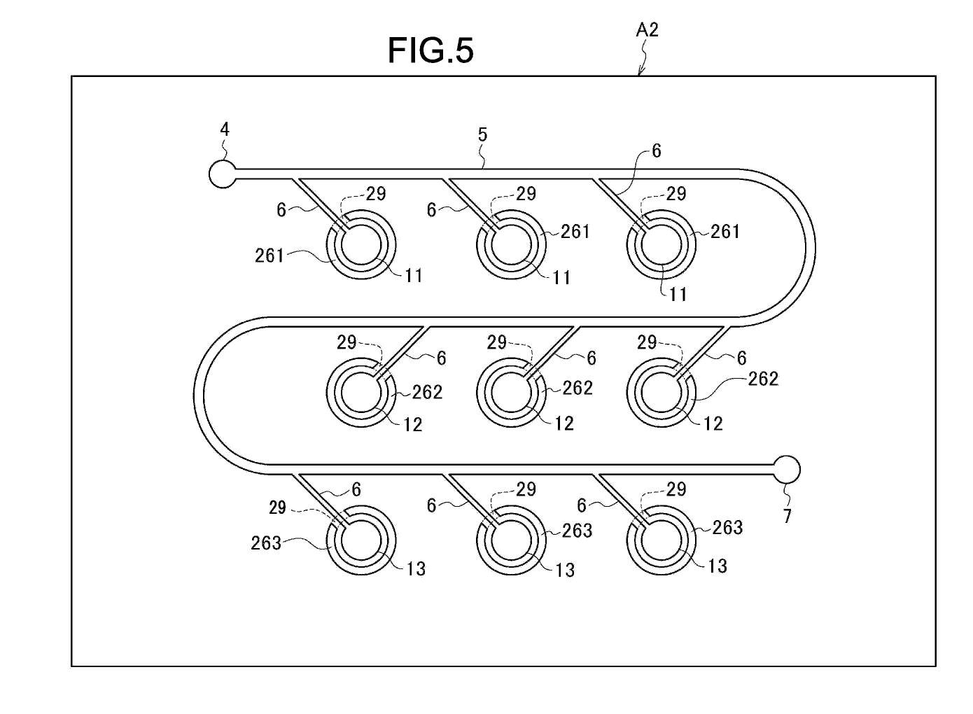

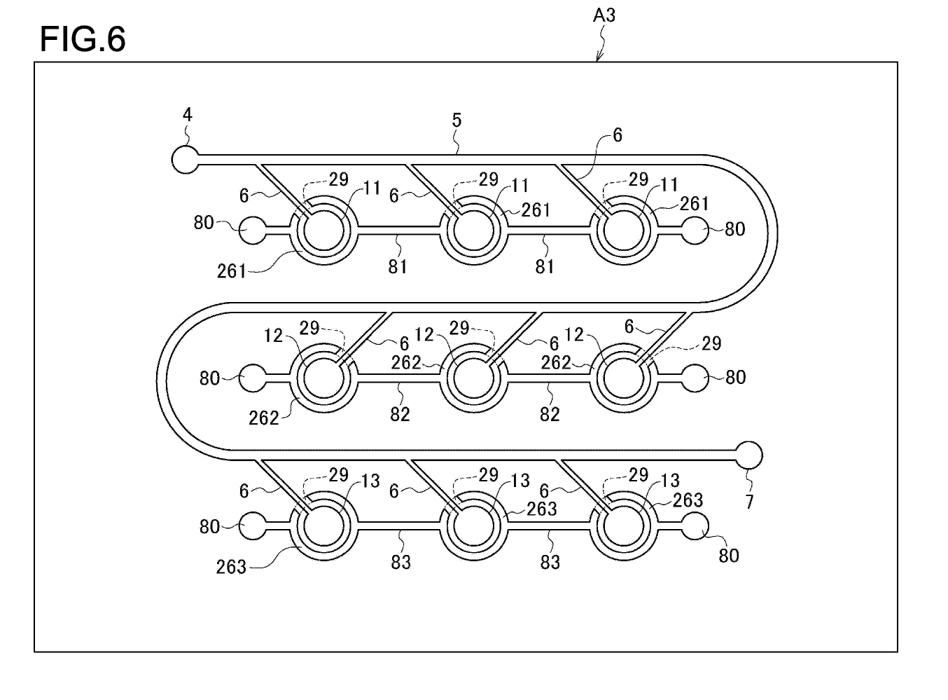

One or more cutouts may be disposed at a part of annular circumferential path 2. Thus, for example, as shown in FIGS. 5 and 6, through the cutout 29, a branched flow channel 6 connected to the well 1 can be provided. The branched flow channel 6 can allow a sample liquid or the like to flow through from a main flow channel 5 to the well 1.

As shown in FIGS. 3A and 3B, at least the first circumferential path 2a or the second circumferential path 2b is disposed around the circumferential part of the well 1 on the surface of the substrate a1 of the microchip A according to an embodiment of the present disclosure.

As shown in FIG. 3C, the first circumferential path 2a and the second circumferential path 2b can be combined to be disposed around the circumferential part of the well 1. The circumferential paths 2 are desirably disposed on both surfaces of the substrate a1 having the well 1. By disposing the first circumferential path 2a and the second circumferential path 2b, a side wall of the well 1 can be easily surrounded by the circumferential paths.

The circumferential paths disposed on both surfaces of the substrate la can block the unnecessary light for the optical detection relatively more effectively. When the insides of the circumferential paths 2 have the pressure negative to atmospheric pressure, the substrate a1 having the well 1 can be further strongly sucked to the counter substrates a2, a3. Also, when the circumferential paths 2 have the negative pressure, a permanent bonding etc. may be avoided so that the substrates are easily peeled after the microchip is used. In addition, as the side wall of the well 1 can be surrounded by the circumferential paths 2, it can inhibit heat release from the inside of the well 1 and inhibit invasion of heat from circumference of the well 1. The function effects such as light blocking properties and thermal insulating properties are easily exerted.

A positional relationship between the first circumferential path 2a and the second circumferential path 2b in a perpendicular direction can be adjusted in response to the function effects such as the light blocking properties and the thermal insulating properties to be intended. In particular, desirably, the first circumferential path 2a and the second circumferential path 2b are disposed in parallel in the enter and exit directions (for example, see FIG. 2B and FIG. 3C).

A blocking of the unnecessary light of incident light L on the microchip A according to a first embodiment shown in FIG. 3A, a second embodiment shown in FIG. 3B and a third embodiment shown in FIG. 3C of the present disclosure will be described below in detail.

As shown in FIG. 3A, when the first circumferential path 2a is disposed in the enter direction, leak light, scattered light, etc. L₂ of the incident light L reflects at a curve of the first circumferential path 2a in the enter direction. The scattered light L from an adjacent well (not shown) reflects at a curve of the second circumferential path 2 in the well 1 in the enter direction. This leads to a decrease in contamination of the unnecessary light for the optical detection and detection light L₁ from the well 1. Thus, it can prevent the unnecessary light for the optical detection from reaching to the optical detection system, and the first circumferential path 2a can block the unnecessary light for the optical detection. It should be noted that the optical detection system is to detect the detection light L₁ from the well 1.

As shown in FIG. 3B, when the second circumferential path 2b is disposed in the exit direction, the unnecessary light for the optical detection L₂, L₃ such as scattered light of the incident light L, leak light from the well 1, diffusion light from an adjacent well (not shown) refracts in outer direction of the well 1. This leads to a decrease in contamination of the unnecessary light for the optical detection and detection light L₁ from the well 1. Thus, it can prevent the unnecessary light for the optical detection from reaching to the optical detection system, and the second circumferential path 2b can block the unnecessary light for the optical detection. It should be noted that the optical detection system is to detect the detection light L₁ from the well 1.

As shown in FIG. 3C, the circumferential paths 2a, 2b are desirably disposed in the enter and exit directions. As described above, by reflection, refraction etc. of the unnecessary light for the optical detection, contamination of the unnecessary light for the optical detection such as leak light, diffusion light etc. and the detection light L₁ from the well 1 is further decreased. Thus, both the first circumferential path 2a and the second circumferential path 2b can prevent the unnecessary light for the optical detection from reaching to the optical detection system that detects the detection light L₁ from the well 1. By utilizing this configuration, the unnecessary light for the optical detection can be more effectively blocked.

Desirably, the inside of either of the first circumferential path 2a and the second circumferential path 2b is at a pressure negative to atmospheric pressure, so the light blocking properties are improved. More desirably, the insides of both are at a pressure negative to atmospheric pressure, so the light blocking properties are further improved.

Also, when the circumferential paths 2 have the negative pressure, the substrate a1 having the well 1 can be strongly bonded to two counter substrates a2, a3. Thus, the substrates will not be bonded with an adhesive agent, a permanent bonding etc., so they can be separated, and cleaned for recycling after the microchip is used. Further, even if the use of the adhesive agent is undesirable or difficult for the counter substrate(s), the bonding of the substrates can be made possible.

Further, the circumferential path 2 according to an embodiment of the present disclosure may contain a light blocking material. Thus, the light blocking properties can be improved so that the detection accuracy can be further improved. The state of the material may be a solid (film-like etc.), a liquid, a gas or the like.

Examples of the light blocking material include, for example, a material that refracts light, a material that reflects light and the like.

The light reflecting material may be any material having high light reflectance. Examples of the material include, for example, one or two or more of metal film material selected from silver, gold, aluminum, rhodium and the like. Of these, silver or the material including silver as a main component is desirable. A reflection film can be formed within the circumferential path 2 using the material by an ion sputtering method. The metal film has a non-limiting thickness, but may be about 30 to 200 nm, desirably about 30 to 70 nm per one layer of the metal film.

The light refracting material is not especially limited, but may be desirably a liquid having high refractive index that is equal to refractive index of pure water or more (more desirably refractive index nD (at 20° C.) of 1.5 to 1.8). Examples of the light refracting liquid include, for example, a silicone oil, an optical oil (immersion oil), an ion liquid, a liquid having high refractive index for photolithography and the like. These may be used alone or in combination of two or more thereof.

The silicone oil may be one which is commercially available, and having refractive index of about 1.3 to 1.6. Specifically, there are dimethyl silicone oil (refractive index: 1.3 to 1.4), methylphenyl silicone oil (refractive index: 1.4 to 1.5), methylhydrogen silicone oil (refractive index: 1.3 to 1.4) and the like.

More specifically, a commercially available dimethyl silicone oil is KF96 (manufactured by Shin-etsu Chemical Co., Ltd.), a commercially available methylphenyl silicone oil is KF50 and KF 54 (manufactured by Shin-etsu Chemical Co., Ltd.), and a commercially available methylhydrogen silicone oil is KF99 (manufactured by Shin-etsu Chemical Co., Ltd.), for example.

These may be used alone or in combination of two or more thereof

The immersion oil may be desirably one which is commercially available that has refractive index of about 1.5 to 1.8. Specifically, a commercially available immersion oil is TypeA, TypeB, TypeNVH, TypeOVH, Type37, Type300, TypeDF, TypeFF (Cargill standard refractive index liquid: MORITEX Corporation) or the like.

The TypeA oil is a synthetic oil having low viscosity for short focus observation where terphenyl, hydrogenated terphenyl, polybutane, hydrocarbon are mixed. The TypeB oil is a synthetic oil having medium viscosity for lenses for medical apparatus. The TypeNVH and the TypeOVH are synthetic oils having high viscosity for long distance observation.

These may be used alone or in combination of two or more thereof

The ion liquid is not especially limited and its example includes a dicationic ion liquid and a dianionic ion liquid. Among them, the dicationic ion liquid is desirable.

Examples of the dicationic ion liquid include an aliphatic ammonium dicationic ion liquid and an aromatic ammonium dicationic ion liquid. Examples of the anion include carboxylate, sulfonate, and sulfate anions. Non-limiting examples of dicarboxylic acid dianion include succinic acid, nonanedioic acid and dodecanedioic acid. Other non-limiting examples of diionic species (dianion and dication having a typical cross-linking group) include the followings (chemical formulae 1 to 5): Protonated tertiary amine (chemical formula 1), tetrahydrothiophenium (chemical formula 2), imidazolium (chemical formula 3), pyrrolidinium (chemical formula 4), and phosphonium (chemical formula 5). Single or a plurality of hydrogen atom(s) in an alkyl group moiety may be substituted with a straight chain or branched alkyl group having 1 to 5 carbon atom(s) (for example, a methyl group, an ethyl group, a propyl group, a butyl group etc.) or an alkyl group having a benzene ring (for example, a benzyl group etc.). In addition, n may be desirably n=1 to 5.

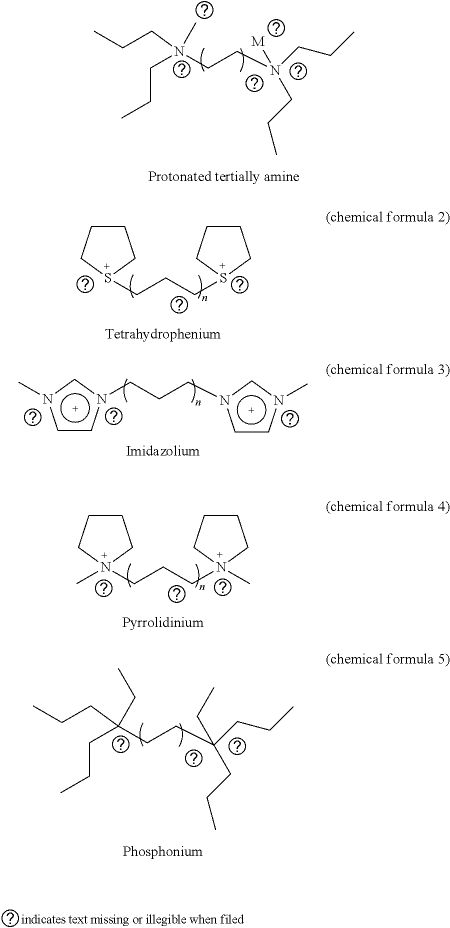

Furthermore, an imidazolium based dicationic ion liquid and a pyrrolidinium based dicationic liquid are desirable. The following chemical formulae 6 to 11 are more desirable, where A represents a salt, and is Br⁻, Cl⁻, I⁻, NTf₂⁻, BF₄⁻, PF₆⁻ or the like, for example.

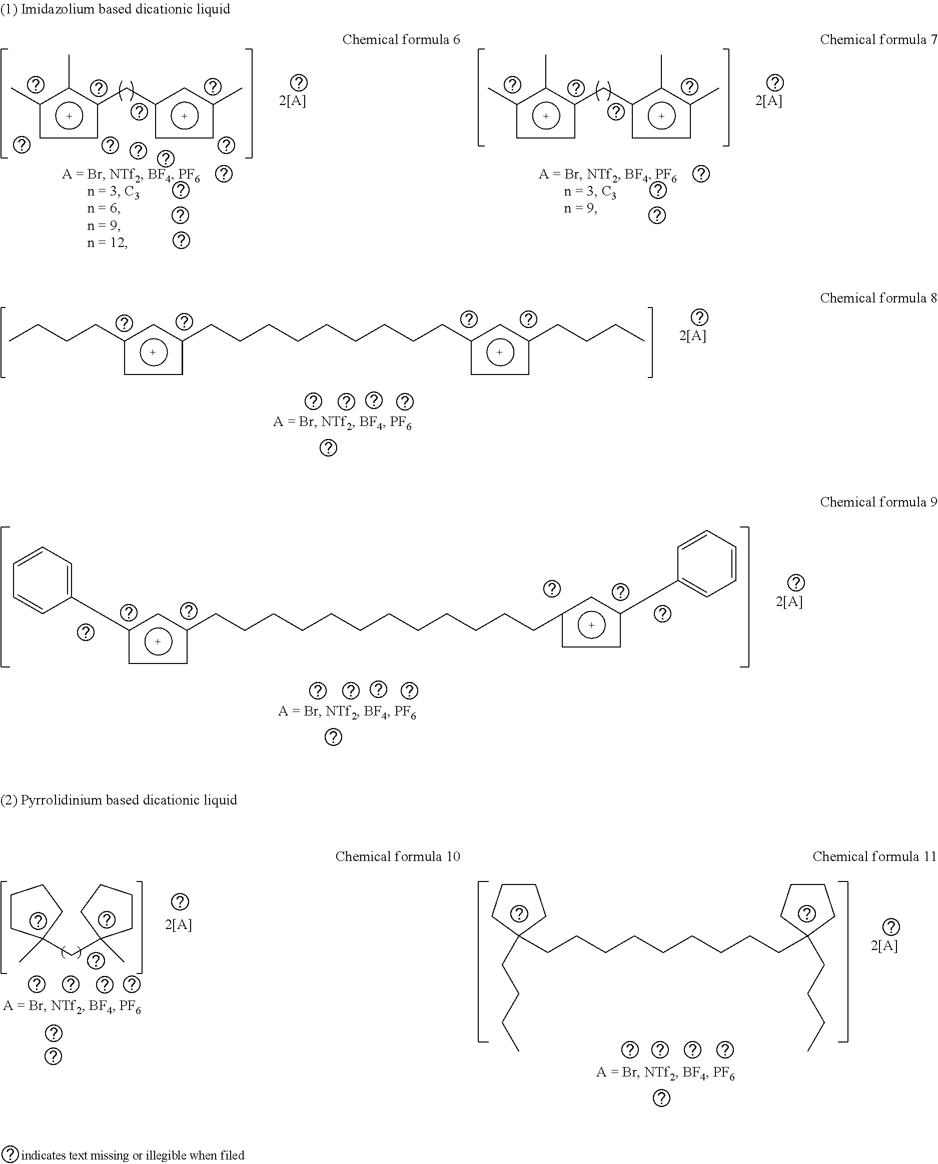

These may be used alone or in combination of two or more thereof.

The liquid having high refractive index for photolithography may include one or a combination of more types of inorganic particles (A) each having a volume average particle diameter of 100 nm or less, prepared so that the refractive index is 1.5 or more. As to the liquid having high refractive index for photolithography, see Japanese Unexamined Patent Application Publication No. 2007-234682, for example. The % by weight and the volume average particle diameter of the inorganic particles may be determined in accordance with JIS R1629-1997 Determination of particle size distributions for fine ceramic raw powders by laser diffraction method.

The inorganic particles in the liquid having high refractive index for photolithography desirably include 90% by weight of the inorganic particles each having a particle diameter of 100 nm or less. Examples of the inorganic particles (A) include metal oxide fine particles, inorganic metal salt fine particles (sulfate, carbonate, phosphate etc.), metal halide fine particles, metal nitride fine particles, metal carbide fine particles, metal boride fine particles, metal fine particles and ceramic fine particles. These may be used in combination of two or more thereof

Specifically, examples of the metal oxide include alumina, tin oxide, titanium oxide, zinc oxide, zirconium oxide, cerium oxide, ferric oxide, antimony oxide, magnesium oxide, chromium oxide, silicon oxide and the like. Examples of the inorganic acid metal salt include calcium sulfate, barium sulfate, calcium carbonate, calcium phosphate, potassium chloride and the like. Examples of the metal nitride include titanium nitride, aluminum nitride, zirconium nitride, chromium nitride, tungsten nitride, silicon nitride and the like. Examples of the metal carbide include titanium carbide, zirconium carbide, tungsten carbide, chromium carbide, niobium carbide, silicon carbide and the like. Examples of the metal boride include titanium boride, zirconium boride, tungsten boride, chromium boride, molybdenum boride and the like. Examples of metal include silver, copper and the like. These may be used in combination of two or more thereof

Depending on the situation, working such as a surface treatment may be performed thereon. Among them, alumina, tin oxide, titanium oxide, zinc oxide, zirconium oxide, cerium oxide, ferric oxide and antimony oxide each having refractive index of 2 to 3 are desirable. From the stand point of refractive index and particle diameter, titanium oxide, zirconium oxide and cerium oxide are particularly desirable. In order to provide the refractive index as high as 1.5 or more, a solid content is desirably 5% by weight or more.

These may be used alone or in combination of two or more thereof

Non-limiting examples of the method of applying the light blocking material to the circumferential path 2 include bonding the light reflecting material to the surface (desirably inner surface) of the circumferential path 2 according to an embodiment of the present disclosure; injecting the light refracting material into the inside of the circumferential path 2 according to an embodiment of the present disclosure, and the like.

The circumferential path 2 according to an embodiment of the present disclosure may include a material having thermal insulating properties. Thus, as the thermal insulating properties can be improved, the accuracy of the temperature control of each well 1 is improved so that the detection accuracy can be further improved. The state of the material may be a solid (film-like etc.), a liquid, a gas or the like.

Non-limiting examples of the thermal insulating material include ceramic beads dispersion used for a heat cut paint and the like. In this case, such material which does not decrease the above-mentioned light blocking properties is desirable.

The circumferential path 2 according to an embodiment of the present disclosure may include a communicating flow channel 8 for communicating with other circumferential path 2. By disposing the communicating flow channel 8, the fluid (liquid, gas) that enhances function effects such as light blocking properties, thermal insulating properties and bonding properties can flow through the flow channel 8 into the inside of the circumferential path 2.

At a circumferential part around the circumferential path 2, an auxiliary path 3 may be further singly- or multiply-disposed. By using the auxiliary path 3, the bonding properties of the counter substrates and the thermal insulating properties of the well 1 at inner circumference are improved.

The circumferential path 2 according to an embodiment of the present disclosure may include a cutout 29. By disposing the cutout 29, the flow channels (main flow channels 5, branched flow channels 6 etc.) that connect each well 1 disposed within the circumferential path 2 are easily and favorably formed. By utilizing the flow channels, it will be possible that a reaction reagent and a sample liquid are easily introduced into each well 1 in a short time.

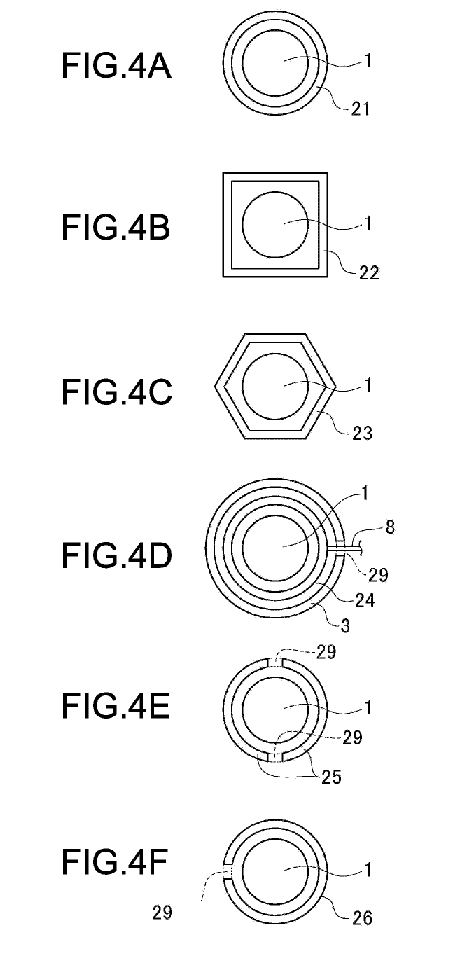

FIGS. 4A to 4F are top views each illustrating the circumferential path 2 formed on the microchip A. Also, FIGS. 4A to 4F are top views each showing the well 1 and the circumferential path 2.

FIG. 4A shows a circumferential path 21 having an almost round circular shape around the circumferential part of the well 1. FIG. 4B shows a circumferential path 22 having a square loop shape around the circumferential part of the well 1. FIG. 4C shows a circumferential path 23 having a polygonal (hexagonal) shape around the circumferential part of the well 1. Among them, the almost round circular shape is desirable in that the light blocking properties and the thermal insulating properties are good.

The branched flow channel 6 may be communicated with the well 1. In this case, the cutout 29 may be disposed at the circumferential path 2. Also, the communicating flow channel 8 may be communicated with the circumferential path 2.

FIG. 4D shows a circumferential path 24 formed around the circumferential part of the well 1, and the communicating flow channel 8 for allowing a fluid to flow around the circumferential path 24. In addition, FIG. 4D shows a case where a C-shaped auxiliary path 3 having the cutout 29 is disposed around the circumferential path 24 in such a way that the communicating flow channel 8 can be formed passing through the cutout 29. The communicating flow channel 8 can allow a fluid having light blocking properties, thermal insulating properties etc. to flow. As the auxiliary path 3 has a negative pressure, the counter substrates a2 and a3 can be strongly bonded together with the substrate a1 having the well 1.

Alternatively, both ends of the auxiliary path 3 may be communicated with each other, without the cutout 29 and the communicating flow channel 8.

The cutout may be disposed at the circumferential path 24 to make the branched flow channel 6 communicate with the well 1.

FIG. 4E shows a circumferential path 25 having a plurality of the cutouts 29 formed around the circumferential part of the well 1. FIG. 4F shows a C-shaped circumferential path 26 having the single cutout 29 around the circumferential part of the well 1. By disposing the cutout 29, a flow channel for allowing a sample liquid etc. to flow into the well 1 can be disposed. Wiring for heat controls or others may be installed through the cutout 29.

(3) Substrate

The substrate (substrate layers a1, a2, a3) of the microchip can be made with glass and a variety of plastics (PP, PC, COP, PMDS etc.), for example. Desirably, the material of the microchip has permeability to measurement light irradiated from a detection part, has less autofluorescence and has little wavelength dispersion, which causes less optical errors.

The well 1, the circumferential path 2 and respective flow channels can be formed on the substrate a1 of the microchip by wet etching or dry etching of a glass substrate, or by nanoimprinting, injection molding or machining of a plastic substrate.

The microchip can be formed by sealing the substrate a1, on which the well 1, the circumferential path 2 and respective flow channels are formed, with substrates a2 and a3 made with the same or different materials. The respective flow channels are not especially limited and include the above-mentioned main flow channel 5, the branched flow channel 6, a feed port 4, a discharge port 7, the communicating flow channel 8, inlet or outlet 80 and the like.

(4) Other Microchip Embodiments According to the Present Disclosure

Hereinafter, other microchip embodiments according to the present disclosure will be described.

FIG. 5 is a schematic top view of a microchip A2 according to an embodiment of the present disclosure.

Each of the wells 11, 12 and 13 is connected to the main flow channel 5 via each of the branched flow channels 6. At each of the circumferential parts of the wells 11, 12 and 13 having the branched flow channels 6, C-shaped circumferential paths 261, 262 and 263 each having the cutout 29 are disposed. Each branched flow channel 6 is formed through each cutout 29. Each of the wells 11, 12 and 13 contains a reaction reagent.

The sample liquid is injected into the feed port 4 of the microchip A2 according to an embodiment of the present disclosure, flows into each of the wells 11, 12 and 13 and is mixed with the reaction reagent. The temperature is controlled, and so on. After the reaction is completed or while the reaction proceeds, optical elements (for example, fluorescence) generated within each of the wells are detected.

The unnecessary light for the optical detection can be blocked at the circumferential paths 261, 262 and 263 according to an embodiment of the present disclosure. The thermal insulation properties are good. By disposing the cutout 29 in each of the circumferential paths 261, 262 and 263 according to an embodiment of the present disclosure, the sample and the like can be transported to the well via the flow channels, which results in improved work efficiency.

The reaction reagent may be unnecessary to be contained in each of the wells 11, 12 and 13.

Using the microchip A2 according to an embodiment of the present disclosure, it is possible to improve optical detection accuracy in chemical and biological analyses in the reaction site.

FIG. 6 is a schematic top view of a microchip A3 according to an embodiment of the present disclosure.

Each of the wells 11, 12 and 13 is connected to one main flow channel via each of the branched flow channels 6. At each of the circumferential parts of the wells 11, 12 and 13 having the branched flow channels 6, C-shaped circumferential paths 261, 262 and 263 each having the cutout 29 are disposed. Each branched flow channel 6 is formed through each cutout 29. Each group of the circumferential paths 261, 262 and 263 is communicated with each of communicating flow channels 81, 82 and 83. At an end of each group of the circumferential paths 261, 262 and 263, the inlet or outlet 80 for allowing the fluid to flow through is disposed.

The sample liquid is injected into the feed port 4 of the microchip A3 according to an embodiment of the present disclosure, flows into each of the wells 11, 12 and 13 and is mixed with the reaction reagent. The temperature is controlled, and so on. After the reaction is completed or while the reaction proceeds, optical elements (for example, fluorescence) generated within each of the wells are detected.

The unnecessary light for the optical detection can be blocked at the circumferential paths 261, 262 and 263 according to an embodiment of the present disclosure.

In the microchip A3, the communicating flow channels 81, 82 and 83 and the inlet or outlet 80 at their ends can use used. By injecting the fluid containing the light blocking material, the thermal insulating material and the like from the inlet or outlet 80, the fluid flows through the communicating flow channels 81, 82 and 83 into the circumferential paths 261, 262 and 263. Thus, it will be possible that the light blocking properties and the thermal insulating properties are further improved.

By disposing the cutout 29 in each of the circumferential paths 261, 262 and 263 according to an embodiment of the present disclosure, the sample and the like can be transported to the well via the flow channels, which results in improved work efficiency.

As each group of the communicating flow channels 81, 82 and 83 is independent, the light blocking properties and the thermal insulating properties of each group of the wells 11, 12 and 13 can be improved. As the communicating flow channels 81, 82 and 83 are connected by disposing a communicating flow channel, the fluid can flow into each of the circumferential paths 261, 262 and 263 by one time injection, which results in improved work efficiency.

The reaction reagent may be unnecessary to be contained in each of the wells 11, 12 and 13.

Using the microchip A3 according to an embodiment of the present disclosure, it is possible to improve optical detection accuracy in chemical and biological analyses in the reaction site.

<2. A Method of Producing a Microchip>

A method of producing a microchip according to an embodiment of the present disclosure includes bonding substrate layers on which a circumferential path 2 is formed at a circumferential part of a reaction zone 1 configured to function as a reaction site on a surface of the substrate a1 at a pressure negative to atmospheric pressure, and sealing hermetically the circumferential path.

Either of the reaction zone 1 or the circumferential path 2 may be formed on the surface of the substrate a1 in advance, or both of the reaction zone 1 and the circumferential path 2 may be formed on the surface of the substrate a1 at the same time. The circumferential path 2 may be formed at least either surface of the substrate a1.

The section form of the circumferential path is curved to block the unnecessary light for the optical detection. The section form is desirably a quadratic curve, more desirably a parabolic curve. The (section or plane) form of the circumferential path to be formed in a perpendicular direction (to the enter and exit directions) is as described above. Examples are shown in FIGS. 4A to 4F. Also, the communicating flow channels for communicating each of the circumferential paths and transporting the fluid, and the inlet or outlet may be formed. In addition, a main flow channel and a branched flow channel that communicate with the reaction zone may be formed on the substrate.

A substrate opposing to the thus-obtained substrate having the reaction zone and the circumferential paths can be formed by etching, injection molding or the like as described above.

The reaction zone 1 may include the reaction reagent such that the reaction reagent is fed, dried by vacuum drying, freeze drying etc. and anchored. The surface of the reaction zone 1 is desirably subjected to a hydrophilic treatment by DP ashing or the like. Also, the areas where the fluid can flow or be transported such as the circumferential path 2, the communicating flow channel 8, the main flow channel 5 and the branched flow channel 6 are desirably subjected to a hydrophilic treatment.

The substrates formed as described above may be bonded at a pressure negative to atmospheric pressure (for example, 1/30 atmosphere or less). Insides of the well 1, the circumferential path 2, each flow channel etc. are hermetically sealed at a pressure negative to atmospheric pressure. It is desirable that the substrates be bonded under vacuum (for example, 1/100 atmosphere or less) for strong bonding. As the inside of the circumferential path 2 has negative pressure, the unnecessary light for the optical detection is easily blocked as described above.

When the substrate a1 having the circumferential path 2 formed on only one surface of the substrate a1 is used, the surface having no circumferential path 2 of the substrate a1 may be bonded to the substrate a2 or the substrate a3 with an adhesive agent or the like, whereby the microchip is formed.

When the substrate a1 having the circumferential paths 2 formed on both surfaces of the substrate a1 is used, the substrate a2 and the substrate a3 may be bonded separately or at the same time at a pressure negative to atmospheric pressure. When the reaction reagent is anchored to the well 1, it is desirable that the substrate a1 be bonded to a substrate a3 out of contact with the well 1 before anchoring. In that case, in order to seal the well 1 after anchoring, the substrate a2 is bonded to form the microchip.

The substrates formed as described above may be bonded by known adhesion method (such as a permanent bonding). However, from the standpoint of reuse of the microchip, a negative pressure in the circumferential path may be desirably used for the bonding as described above.

In the microchip in the past, the geometry of the well and the channel structure tend to be finer. Also, in the microchip in the past, when the well is irradiated externally with light by a transmission optical system in order to optically detect the reaction in the well, the accuracy of the optical detection may be decreased. Along with the finer geometry and structure, when the addressed well is irradiated with transmitted light and reflected light for probing the well, light is diffused within the microchip and at surrounding environment in a complex mode. For example, light entered on the well is diffused, and light leaked to an adjacent well not addressed is generated. The leak light will flow into the adjacent well, so that light (information) may be detected undesirably other than the optical elements (information) of the subject well to be evaluated. The intensity of the optical elements thus obtained is output as the information, which may cause signal contamination. As it is relatively difficult to decrease the contamination to as low as zero, there is a problem that it is considered important to increase its S/N ratio by adjusting optical detector or the like.

In contrast, in the microchip A according to an embodiment of the present disclosure, the circumferential path 2 is disposed around the circumferential part of the microchip A according to an embodiment of the present disclosure as described above, so that the unnecessary light such as leak light for the optical detection can be blocked. Thus, the above-mentioned problem can be solved.

In the microchip in the past, a channel is formed on a substrate made of a material such as a synthetic resin, a well, which will be input and output ports, is formed on one end of the channel, and a counter substrate including an opaque or transparent material is bonded to a bottom surface of the substrate. Examples of the material include glass, a synthetic resin film and the like. The counter substrate serves to seal the bottom surfaces of the wells and the channels.

A method of producing a microchip including bonding a PDMS substrate which is an elastomer type silicon resin with a counter substrate is described, for example, in Japanese Unexamined Patent Application Publication No. 2005-249540. The PDMS has good mold transfer properties to a master (a mold) having a microstructure such as a channel, transparency, chemical resistance, biocompatibility and the like, and has thus notably such excellent properties as a construction material of the microchip.

A further advantage in producing the PDMS microchip is that a permanent bonding can be used to bond the PDMS substrate to the counter substrate. The permanent bonding has a property that the PDMS substrate and the counter substrate can be bonded mutually only by a certain type of surface modification with no adhesive agent. As a result, the microstructure such as a pipeline, a container and/or a port can be well sealed. In the permanent bonding of the PDMS substrate, bonding surfaces of both substrates are surface-modified as appropriate, overlapped intimately and allowed to stand for a given length of time, so that they are bonded easily.

However, practically, in the case described below, the permanent bonding is not necessarily desirable, and it may be desirable that the counter substrates be bonded not by the permanent bonding but by the self-bonding properties of PDMS.

The microchip in the past including the counter substrates bonded by the self-bonding properties of PDMS may have a problem that a liquid reagent or a test body injected leaks from a fine flow channel depending on applications, as the bonding strength is insufficient.

Also, in the microchip in the past, it is possible that a circular pipeline may be formed around the microchip in order for strong bonding under reduced pressure, but there is a problem that the chip may grow in size.

In contrast, in the microchip A according to an embodiment of the present disclosure, by disposing the circumferential path 2 having a negative pressure at the circumferential part in each well, the bonding strength can be increased. Thus, the fluid hardly leaks and the chip does not grow in size. Furthermore, as the circumferential paths 2 such as the first circumferential path 2a and the second circumferential path 2b can be formed on both surfaces of the substrate a1 having the well 1, the counter substrates a2 and a3 can be strongly bonded thereto. An auxiliary path 3 may be further disposed as a single layer or a multilayer around the circumferential path 2, so that the bonding strength can be further increased.

When reagents are reacted in the microchip, the reaction is controlled mostly by a heating mechanism. The microchip may also be heated or cooled by a heating or cooling mechanism. In this case, for providing thermal conductivity of the well, a uniform heat control of the microchip is very important. This is because a temperature difference between a center of the chip and a circumference of the chip is significant as heat is dissipated around the chip. When a heater is disposed nearest the chip, irradiation is performed by a distantly-positioned optical system. However, there would be a problem in this case that the leak light is increased and the S/N ratio is lowered.

In contrast, in the microchip A according to an embodiment of the present disclosure, by disposing the circumferential path 2 having a negative pressure at the circumferential part in each well, it is possible to decrease heat release from the well 1 and decrease invasion of heat from an adjacent well. Furthermore, the circumferential paths 2 such as the first circumferential path 2a and the second circumferential path 2b can be formed on both surfaces of the substrate a1 having the well 1. The circumferential paths 2a and 2b having thermal insulating properties can surround the well 1 laterally in the enter and exit directions. Thus, heat dissipation around the chip can be prevented. Also, an auxiliary path 3 can be further disposed as a single layer or a multiple layer disposed around the circumferential path 2, so that an effect of thermal insulation can be further increased.

As the microchip A according to an embodiment of the present disclosure can simply provide the thermal insulation, a heater is not necessarily needed to be disposed nearest the chip, so a decrease in the optical detection accuracy due to the disposition of the heater can be prevented.

In the microchip in the past, the PDMS substrate has to be subjected to adequate surface modification as a pre-treatment for permanent bonding. The surface modification is, for example, oxygen plasma treatment by a reactive ion etching (RIE) apparatus. Therefore, such a treatment may increase production costs of the microchip.

In contrast, in the microchip A according to an embodiment of the present disclosure, the treatment (production process) can be omitted, whereby significantly decreasing the production costs.

The microchip in the past may use the counter substrates that are not bonded or hardly bonded by the permanent bonding.

For example, poly(methyl methacrylate) (PMMA) is a very popular high-transparent resin. Polycarbonate (PPC) has high heat resistance, and is advantageous for a chemical reaction at high temperature, such as PCR, which is one of DNA amplifications. Cyclo olefin polymer (COP) has high chemical resistance to a variety of reagents.

However, the counter substrate made of these resins and the PDMS substrate are unfortunately difficult to be permanently bonded.

Polyethylene (PE) and polystyrene (PS) can be permanently bonded. However, bonding may be very difficult for the following reasons:

In general, the counter substrates made of these synthetic resins have low resistance to the surface modification for the permanent bonding. Moreover, they have too low processing strengths and narrow acceptable ranges for permanently bonding. For example, in the oxygen plasma treatment by a reactive ion etching (RIE) apparatus, glass is hardly permanent bonded if an RF output exceeds 150 W and an irradiation time exceeds 15 seconds. On the other hand, polyethylene resin is hardly permanent bonded if an RF output exceeds 25 W and an irradiation time exceeds 10 seconds.

In addition, it is difficult to generate plasma stably with a weak RF output within an extremely short time. It easily shows variations in the processing strength. Therefore, it is difficult to bond the synthetic resin substrates and the PDMS substrate stably. Such variations in the processing strength are considered to be one of the reasons of difficulty in permanent bonding of the synthetic resin substrate and the PDMS substrate with good reproducibility.

In contrast, in the microchip according to an embodiment of the present disclosure, the substrates can be strongly bonded together by the negative pressure of the circumferential path 2. Therefore, even when the PDMS substrate and one or two or more of the substrate(s) selected from PMMA, PPC, PE and PS are used, it is possible to bond them successfully.

After the permanently bonded microchip in the past is used, the PDMS substrate, which is plastic, and a silicon or glass substrate, which is an inorganic matter, are separated and discarded, which requires time and effort.

In contrast, in the microchip according to an embodiment of the present disclosure, as the substrates are bonded by the negative pressure of the circumferential path 2, the substrates are more easily peeled than those bonded by the permanent bonding. Thus, work efficiency is good.

In the permanently bonded microchip in the past, the substrates are hard to be peeled. Even if they are peeled, the substrates are likely to be damaged. Therefore, it is difficult to clean and reuse the substrates after the microchip is used. Thus, there is a problem that cost reduction is difficult by the microchip in the past.

In contrast, in the microchip according to an embodiment of the present disclosure, as the substrates are bonded by the negative pressure of the circumferential path 2, the substrates are more easily peeled than those bonded by the permanent bonding. Thus, the substrates will not be damaged upon peeling, work efficiency is good, and costs can be easily decreased.

By peeling, the microstructure in the substrates is not only easily cleaned, but also sufficiently cleaned. After cleaning, the substrates can be bonded to other substrate(s) and reused.

In the microchip in the past, a wiring pattern such as an electrode, an electric heater and a temperature sensor may be formed on a glass substrate, or a micro valve, a micro pump and the like may be formed on a silicon substrate by MEMS technology. The formation is so expensive such that one-time use and discard are extremely uneconomical.

In contrast, in the microchip according to an embodiment of the present disclosure, the circumferential path 2 is formed not on the counter substrates, but on the substrate having the well. As the counter substrates such as a glass or silicon substrate to which complex working is applied are bonded by the negative pressure of the circumferential path 2, the substrates are more easily peeled with no damage. After peeling, it is possible to clean and reuse the counter substrate to which complex working is applied. By cleaning and reusing such expensive substrates, costs can be decreased.

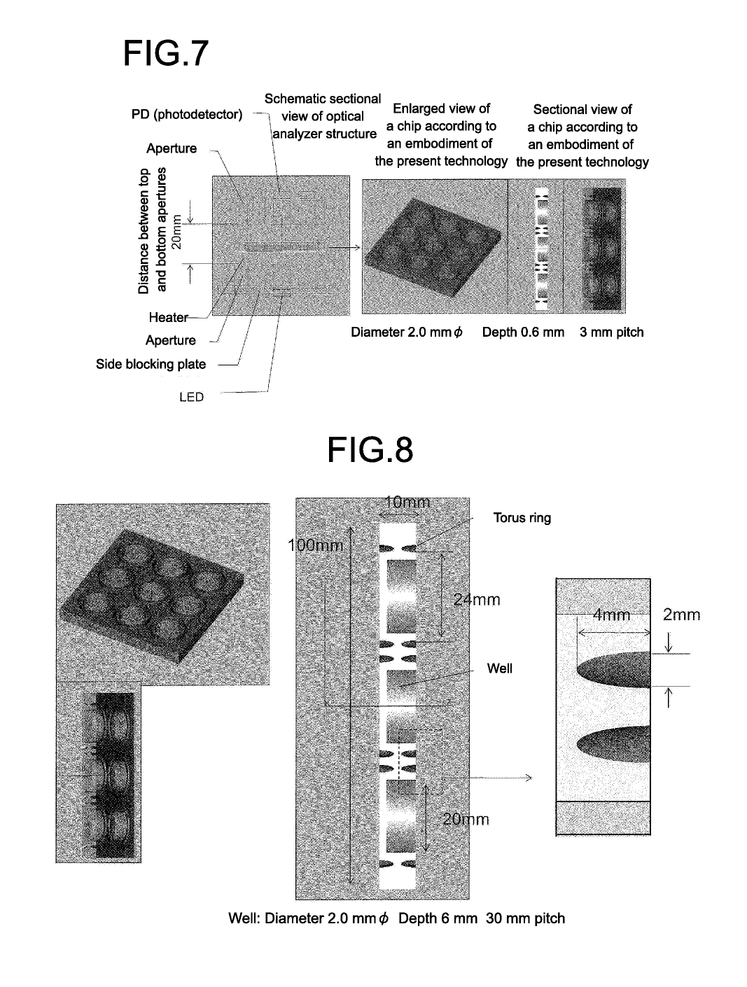

The microchip according to an embodiment of the present disclosure provides increased optical detection accuracy in a general optical detector as shown in Examples (see FIGS. 7 to 10) as described later as compared with the microchip in the past.

In other words, surprisingly, the present inventors have achieved the microchip according to an embodiment of the present disclosure and confirmed that it has pronounced effects that the optical detection accuracy is increased. A distance between the light source and the plane in the enter direction of the microchip according to an embodiment of the present disclosure is desirably 0 to 20 mm, more desirably 0 to 15 mm. The distance is represented by the numerical value as generally set in the optical detector.

When the microchip according to an embodiment of the present disclosure (desirably, see FIG. 2B) is mounted on the optical detector, the unnecessary light (such as leak light) for the optical detection can be blocked more successfully without any adjustment of the optical detection by the optical detector.

<Optical Detector>

The microchip according to an embodiment of the present disclosure can be used by mounting on the optical detector. The optical detector (not shown) can desirably perform various reactions (for example, a nucleic acid amplification reaction), and includes, for example, a light guide plate, a reflector, an illuminator, an excitation filter, a fluorescent filter and an optical detection system (optical detection part). There may be disposed a light guide member for adjusting a light flow and a heat controller for controlling a reaction temperature. Also, there may be disposed a pin hole, a variety of filters, a light collecting lens and a support, for adjusting amount of light, an optic element etc. and supporting each system (part), as appropriate.

Desirably, a controller (CPU etc.) for controlling a variety of operations (for example, light control, temperature control, a nucleic acid amplification reaction, detection control, calculation of detected light amount, monitoring etc.) may be provided.

Examples of a light source (the illuminator) include a laser light source, a white or monochrome light emitting diode (LED), a mercury lamp, a tungsten lamp and the like.

The laser light source may be any light source from which exits argon ion (Ar) laser, helium-neon (He—Ne) laser, dye laser, krypton (Kr) laser etc. The laser light source can be used alone or in combination of two or more thereof freely.

The detection system may be a mechanism that can detect light amount exited from other end (specifically a bottom) of the reaction zone 2. The detection system includes at least an optical detector.

The optical detector is not especially limited, and includes an area imaging apparatus such as a photodiode (PD) array, a CCD image sensor, a CMOS image sensor etc., a small light sensor, a line sensor scan, a PMT (photomultiplier) and the like. These may be combined as appropriate.

The excitation filter and the detection filter that are corresponded to various reactions may be used. Commercially available filters may be used.

<Nucleic Acid Amplification Reaction>

The microchip according to an embodiment of the present disclosure can be used in various chemical reactions for optical detection, for example, a nucleic acid amplification reaction and detection (for example, a reaction by Benedict's reagent) of a reducing sugar (for example, maltose, fructose, glucose etc.).

According to the present disclosure, “the nucleic acid amplification reaction” includes a PCR (Polymerase Chain Reaction) method and “an isothermal amplification reaction”. “The reaction reagent” includes a substance that is used for a reaction to provide amplified nucleic acid strands in the nucleic acid amplification reaction. “The substance that is used for the reaction” is to provide the amplified nucleic acid strands in the nucleic acid amplification reaction. Specific examples include an oligonucleotide primer complementary to a base sequence of target nucleic acid strands, a nucleic acid monomer (dNTP), an enzyme, a reaction buffer solution (buffer) solute and the like.

The PCR method is to amplify template nucleic acid strands by repeating a temperature cycle including three steps of (1) thermal denaturation, (2) annealing and (3) elongation. The reaction is performed in each of the reaction zone 1. The (1) thermal denaturation is the step of dissociating double strands into single strands of the template nucleic acid strands. The reaction temperature of the thermal denaturation is generally about 94° C. The (2) annealing is the step of bonding an oligonucleotide primer to the template nucleic acid strands including single strands dissociated. The reaction temperature of the annealing is generally about 50 to 60° C. The (3) elongation is the step of synthesizing DNAs complementary to the single strand parts by DNA polymerase used as an origin where the oligonucleotide primer is bonded. The reaction temperature of the elongation is generally about 72° C.

A fluorescent pigment such as SYBR™ Green I is intercalated to ds (double-stranded)-DNAs generated in a DNA replication reaction. The intercalated ds-DNAs are irradiated with the excitation light and excited to produce fluorescence (for example, the excitation light of 497 nm: emission wavelength of 520 nm). Desirable fluorescent components are separated by a fluorescent filter. The amount of fluorescence is determined by a fluorescence detection system per the temperature cycle, and is quantified. Based on a correlation between the number of the temperature cycles and the amount of fluorescence corresponding thereto, an initial amount of cDNAs can be determined as a genetic expression amount.

As to the PCR method, nucleic acids can be quantified by using a turbidity substance.

According to the present disclosure, “the nucleic acid isothermal amplification reaction” includes various amplification reactions involving no temperature cycle. Examples of the isothermal amplification reaction include a LAMP (Loop-Mediated Isothermal Amplification) method, a SMAP (SmartAmplification Process) method, a NASBA (Nucleic Acid Sequence-Based Amplification) method, an ICAN (Isothermal and Chimeric primer-initiated Amplification of Nucleic acids) method™, a TRC (transcription-reverse transcription concerted) method, an SDA (strand displacement amplification) method, a TMA (transcription-mediated amplification) method, an RCA (rolling circle amplification) method and the like. “The nucleic acid amplification method” involves a wide variety of isothermal nucleic acid amplification reactions for amplifying nucleic acids. These nucleic acid amplification reactions involve a reaction for amplifying nucleic acid strands and quantifying the nucleic acid strands amplified, e.g., a real time (RT)-LAMP method.

As an example of the nucleic acid amplification reaction, the LAMP method will be described below. The nucleic acids are quantified by a turbidity substance in the LAMP method in the example described below. The reaction is performed in each of the reaction zone 1.

By setting a constant temperature (60 to 65° C.), the nucleic acids are amplified. The LAMP method does not require thermal denaturation for dissociating double strands into single strands. At the isothermal conditions, annealing of a primer and elongation of nucleic acids are repeated.

As a result of the nucleic acid amplification reaction, pyrophosphoric acid is produced. Metal ions are bonded to the pyrophosphoric acid to form an insoluble or poorly-soluble salt. The salt will be a turbidity substance (measuring wavelength of 300 to 800 nm). The turbidity substance is irradiated with incident light to be scattered light. An amount of the scattered light transmitted through the fluorescent filter is determined and quantified by a real time fluorescence detection system. An amount of transmitted light can be quantified.

Also, the LAMP method can quantify nucleic acids by using a fluorescent substance.

### EXAMPLE

Hereinafter, specific embodiments will be described. The present disclosure is not limited thereto.

### Example 1

Experimental Material

A PDMS substrate a1 having ring grooves with parabolic curves on both surfaces, on which nine wells were formed, was used.

A LAMP reaction solution was used.

As a fluorescent pigment, SYBR Green I (SG: Molecular Probes Inc.) was used.

A method of producing a microchip A2 according to an embodiment of to the present disclosure and a test method using the same

A transparent chip a1 with a microwell 1 having flow channels 5 and 6 formed by molding PDMS resin into a mold was produced.

A groove for a C-shaped pipeline 26 having a parabolic curve was formed around the flow channels 5 and 6 and the well 1 for providing a reagent with a solid phase on a surface of a substrate a1. Also, the C-shaped pipeline 26 having the parabolic curve was formed around the well 1 on a rear surface thereof

Thus, the PDMS substrate a1 to be used below was provided.

Bonding of a bottom of the PDMS substrate a1 will be described.

The PDMS substrate a1 was subjected to DP ashing under the conditions of O₂: 10 cc, 100 W and 30 sec to subject to the hydrophilic treatment, and was bonded to a cover glass a3 under vacuum. The glass a3 was faced down, and the surface having the well 1 for providing a reagent with a solid phase was faced up.

A LAMP reaction solution containing a LAMP primer for a target (template) nucleic acid was prepared.

A BST enzyme and 0.1 μL of a primer solution were preliminarily dispensed per microchip well 1 to induce the LAMP reaction, and were anchored by vacuum drying. The BST enzyme: stock solution, the LAMP primer: six liquids mixture (FIP, BIP, F3, B3, LF, LB). A microdispenser was used to anchor the primer to the bottom of the well 1 and freeze dry it.

Bonding of a top of the PDMS substrate a1 will be described below. At the flow channels 5 and 6 sides, the PDMS substrate a1 was subjected to DP ashing under the conditions of O₂: 10 cc, 100 W and 30 sec to subject to the hydrophilic treatment, as described above, and was bonded to a cover glass a2 under reduced pressure ( 1/100 atm or less).

Thus, an alternative embodiment according to the present disclosure of a microchip A2 was provided.

The alternative embodiment according to the present disclosure of the microchip A2 will be used as follows: The optical detector is not especially limited, and optical detection is disposed below.

Injection: a test body pre-treatment solution with which an intercalator fluorescent substance is mixed is fed into the flow channels 5 and 6 at the reagent position side within the chip through the PDMS by a pain-free needle. As the flow channels 5 and 6 have reduced pressure, the liquid forced by atmospheric pressure is climbed down the needle to be filled within the flow channel in a short time.

An amplification reaction monitor: After water is injected, the chip is set quickly on a heating fluorescence detection apparatus equipped with a fluorescence detection part to monitor a nucleic acid amplification reaction. The apparatus is configured to irradiate each well 1 of the microchip substrate with excited light including LED from above concurrently with heating of the microchip, whereby fluorescence transmitted through the reaction zone 1 is detected. A probe such as a fluorescent substance in the reaction liquid within the reaction site is irradiated with the excited light to generate fluorescence. The fluorescence is detected and measured by a fluorescence detection photodetector disposed downward at the reaction zone 1 of the microchip substrate, which is positioned on an optical axis of an excitation light source.

Also, using the microchip according to an embodiment of the present disclosure, an apparatus for entering excited light from a bottom of the microchip and detecting fluorescence generated in the well 1 by a fluorescence detector placed on the top can detect and measure similar to the above-mentioned apparatus.

### Example 2

FIGS. 7 and 8 show a configuration of an optical detector for a calculation model using the microchip A according to an embodiment of the present disclosure. The well of the microchip has a diameter of 2.0 mmφ, a depth of 0.6 mm and a pitch of 3 mm. The microchip according to an embodiment of the present disclosure included the first circumferential path 2a and the second circumferential path 2b around the circumferential part of the well 1. The microchip in the past had no circumferential path (torus ring).

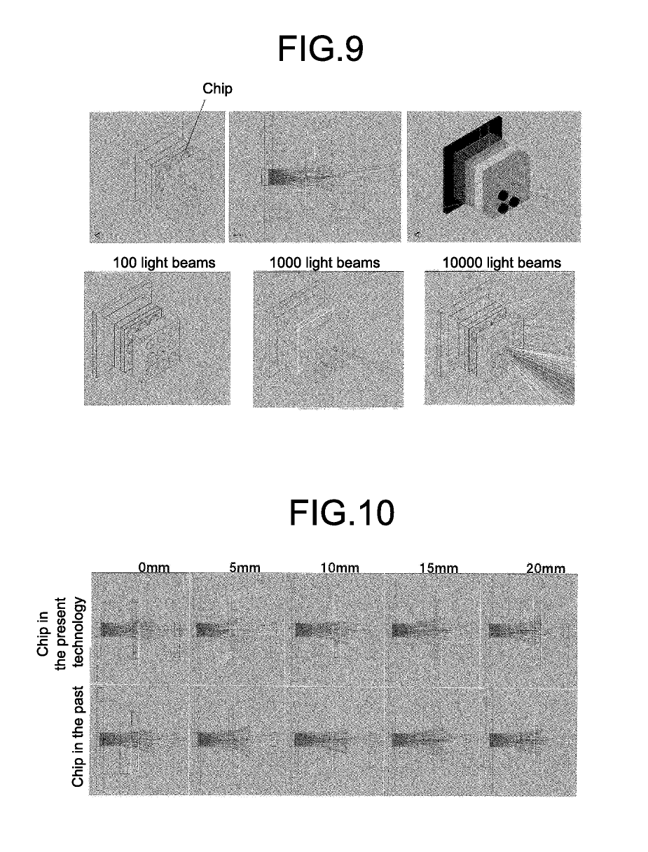

FIG. 9 shows light flows of 100, 1000 and 10000 light beams by the calculation model.

FIG. 10 shows light flows of the microchips according to the embodiments of the present disclosure and of the microchips in the past when a distance from a light source to a bottom of the chip is adjusted to 0 to 20 mm in each chip by the calculation model.

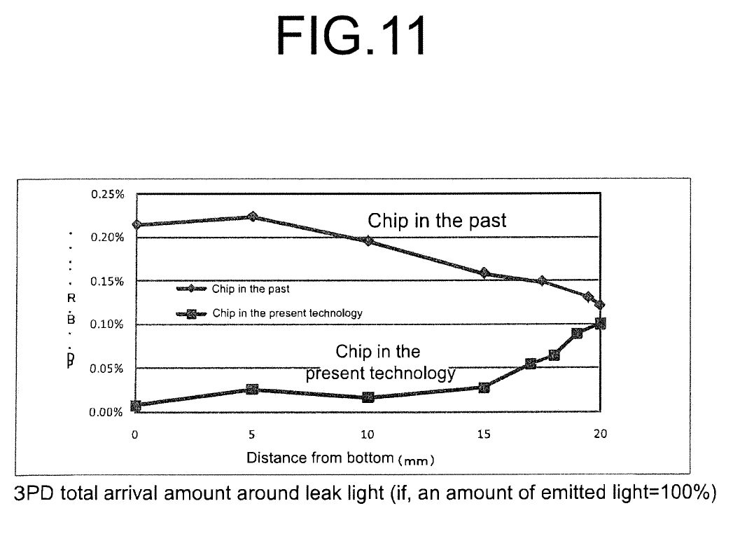

FIG. 11 is a graph showing a 3PD total arrival amount (when an amount of emitted light from light source is supposed to be 100%) around leak light by the calculation model.

As shown in FIGS. 7 to 11, the microchip according to an embodiment of the present disclosure provides increased optical detection accuracy in a general optical detector as compared with the microchip in the past.

In other words, totally surprisingly, the present inventors have achieved the microchip according to an embodiment of the present disclosure and confirmed that it has pronounced effects that the optical detection accuracy is high. A distance between the light source and the plane in the enter direction of the microchip according to an embodiment of the present disclosure is desirably 0 to 20 mm, more desirably 0 to 15 mm. The distance is represented by the numerical value as generally set in the optical detector.

When the microchip A according to an embodiment of the present disclosure (desirably, see FIG. 2B) is mounted on the optical detector, the unnecessary light such as leak light for the optical detection can be blocked more successfully without any adjustment of the optical detection by the optical detector.

The present disclosure may have the following configurations.

[1] A microchip including a plurality of substrates bonded together; a reaction zone, provided on at least one of the substrates, configured to function as a reaction site of a reaction; and a circumferential path on a circumferential part of the reaction zone with an inside of the circumferential path being at a pressure negative to atmospheric pressure, disposed on at least one side of at least one of the substrates bonded together. Or, a microchip including a plurality of substrates, having a circumferential path on a circumferential part of a reaction zone configured to function as a reaction site of a reaction, with an inside of the circumferential path being at a pressure negative to atmospheric pressure, and is disposed on at least one side of at least one of the substrates bonded together.

[2] The microchip according to [1] above, in which the circumferential paths are disposed on both surfaces of at least one of the substrates on which the reaction site is formed.

[3] The microchip according to [1] or [2] above, in which a section form of the circumferential path is curved to block unnecessary light for optical detection.

[4] The microchip according to any one of [1] or [3] above, in which the circumferential path has thermal insulating properties.

[5] The microchip according to any one of [1] or [4] above, in which the circumferential path has a cutout.

[6] The microchip according to any one of [1] or [5] above, in which each of the circumferential paths is connected to a communicating flow channel, and a fluid flows from the communicating flow channel to the circumferential path.

[7] The microchip according to any one of [1] or [6] above, which is used for a nucleic acid amplification reaction.

[8] A method of producing a microchip, including:

bonding substrate layers on which a circumferential path is formed around a circumferential part of a reaction zone configured to function as a reaction site on a surface of a substrate that is one of the substrate layers, at a pressure negative to atmospheric pressure; and

sealing hermetically the circumferential path.

[9] The method of producing a microchip according to [8], further including:

curving a section form of the circumferential path to block unnecessary light for optical detection.

[10] The method of producing a microchip according to any one of [1] to [7].

### INDUSTRIAL APPLICABILITY

The microchip according to an embodiment of the present disclosure can be used for chemical and biological analyses in the reaction zone configured to function as the reaction site. Also, the optical detection accuracy is high without any adjustment for improving the optical detection by the optical detector.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A microchip, comprising:
a plurality of substrates bonded together;
a reaction zone, provided on at least one of the substrates, configured to function as a reaction site of a reaction; and
a circumferential path on a circumferential part of the reaction zone with an inside of the circumferential path being at a pressure negative to atmospheric pressure, disposed on at least one side of at least one of the substrates bonded together.

2. The microchip according to claim 1, wherein a section form of the circumferential path is curved to block unnecessary light for optical detection.

3. The microchip according to claim 2, wherein
the circumferential paths are disposed on both surfaces of at least one of the substrates on which the reaction site is formed.

4. The microchip according to claim 3, wherein
the circumferential path has thermal insulating properties.

5. The microchip according to claim 3, wherein
the circumferential path has a cutout.

6. The microchip according to claim 3, wherein
each of the circumferential paths is connected to a communicating flow channel, and a fluid flows from the communicating flow channel to the circumferential path.

7. The microchip according to claim 3, which is used for a nucleic acid amplification reaction.

8. A method of producing a microchip, the method comprising:
bonding substrate layers on which a circumferential path is formed around a circumferential part of a reaction zone configured to function as a reaction site on a surface of a substrate that is one of the substrate layers, at a pressure negative to atmospheric pressure; and
sealing hermetically the circumferential path.

9. The method of producing a microchip according to claim 8, further comprising:
curving a section form of the circumferential path to block unnecessary light for optical detection.
